(19) United States
(12) Patent Application Publication
(10) Pub. No.: US 2014/0060348 A1
(43) Pub. Date: Mar. 6, 2014

(54) MOISTURE SENSOR FOR A COTTON ROUND MODULE BUILDER

(71) Applicants: JERRY B. HALL, Johnston, IA (US); James J. Phelan, Bettendorf, IA (US); Ryan E. Noble, Polk City, IA (US)

(72) Inventors: JERRY B. HALL, Johnston, IA (US); James J. Phelan, Bettendorf, IA (US); Ryan E. Noble, Polk City, IA (US)

(21) Appl. No.: 13/596,394

(22) Filed: Aug. 28, 2012

(51) Int. Cl. B30B 9/30

(52) U.S. Cl. 100/99

(57) ABSTRACT

A round module builder for forming a round bale of cotton is disclosed. The round module builder is configured to receive compressed cotton and form a round bale of cotton. At least one moisture sensor is coupleable to the round module builder. The moisture sensor is configured to measure an indication of a moisture level of the cotton.

### FIELD OF THE DISCLOSURE

The present disclosure generally relates to cotton round module builders, and more particularly to moisture sensors for cotton round module builders.

### BACKGROUND OF THE DISCLOSURE

In order to measure the moisture content of a round bale of cotton, a moisture sensing probe is commonly used after the round bale is formed by an operator or by a cotton gin. The moisture sensing probe typically includes a resistance sensor or a capacitance sensor.

### SUMMARY OF THE DISCLOSURE

In one embodiment, a cotton harvester is disclosed. A harvesting structure is configured to remove cotton from a field. An accumulator is in communication with the harvesting structure for receiving cotton therefrom. A feeder is in communication with the accumulator for receiving cotton therefrom. The feeder is configured to compress the cotton. A round module builder is in communication with the feeder for receiving cotton therefrom. The round module builder is configured to form a round bale of cotton. At least one moisture sensor is coupleable to at least one of the accumulator, the feeder, and the round module builder. The moisture sensor is configured to measure an indication of a moisture level of the cotton.

In another embodiment, a round module builder for forming a round bale of cotton is disclosed. The round module builder includes a first module-forming portion that is configured to receive compressed cotton. A second module-forming portion is pivotally coupleable to the first module-forming portion. The first module-forming portion and the second module-forming portion are configured to rotate the cotton into the round bale. An extendable and retractable cylinder is coupleable to the second module-forming portion and configured to pivot the second module-forming portion relative to the first module-forming portion. At least one moisture sensor is coupleable to at least one of the first module-forming portion and the second module-forming portion. The moisture sensor is configured to measure a first indication of a first moisture level of the cotton adjacent an innermost portion of the round bale of cotton and a second indication of a second moisture level of the cotton adjacent an outermost portion of the round bale of cotton.

In yet another embodiment, a method of baling cotton is disclosed. The method includes compressing harvested cotton. The method includes measuring a first indication of a first moisture level of the cotton adjacent an innermost portion of the round bale of cotton and a second indication of a second moisture level of the cotton adjacent an outermost portion of the round bale of cotton. The method includes ejecting the round bale of cotton from a round module builder.

Other features and aspects will become apparent by consideration of the detailed description and accompanying drawings.

### BRIEF DESCRIPTION OF THE DRAWINGS

FIG. 1 is a side view of a cotton harvester including a round module builder according to one embodiment.

FIG. 2 is a schematic view of the cotton harvester of FIG. 1.

FIG. 3 is a flowchart of the cotton harvester of FIG. 1.

FIG. 4 is a side view of a cotton harvester including a round module builder according to another embodiment.

FIG. 5 is a side view of a cotton harvester including a round module builder according to yet another embodiment.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

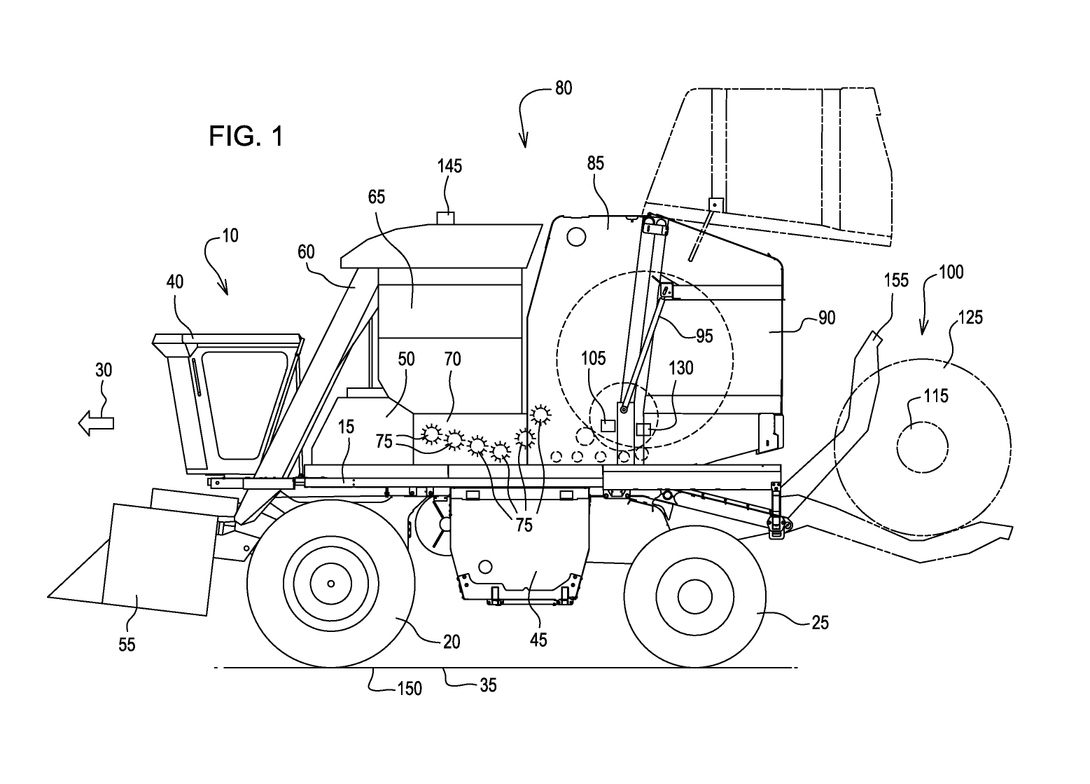

FIG. 1 illustrates a cotton harvester 10 according to one embodiment. The illustrated cotton harvester 10 includes a chassis 15. The chassis is supported by front wheels 20 and rear wheels 25. The cotton harvester 10 is adapted for movement in a forward direction 30 through a field 35 to harvest cotton. An operator station 40 is supported by the chassis 15. A power module 45 may be supported below the chassis 15. Water, lubricant, and fuel tanks, indicated generally at 50, may be supported on the chassis 15.

A harvesting structure 55 is coupleable to the chassis 15. The harvesting structure 55 is configured to remove cotton from the field 35. An air duct system 60 is coupleable to the harvesting structure 55. An accumulator 65 is coupleable to the air duct system 60. The accumulator 65 is configured to receive cotton from the harvesting structure 55 via the air duct system 60. A feeder 70 is coupleable to the chassis 15. The feeder 70 is configured to receive cotton from the accumulator 65. The feeder 70 includes a plurality of rollers 75 configured to compress the cotton and transfer the cotton to a round module builder 80. Advantageously, compressed cotton enables a more accurate determination of cotton moisture.

The illustrated round module builder 80 includes a first module-forming portion 85 in communication with the feeder 70. A second module-forming portion 90 is pivotally coupleable to the first module-forming portion 85. An extendable and retractable cylinder 95 is coupleable to the second module-forming portion 90. The extendable and retractable cylinder 95 is configured to pivot the second module-forming portion 90 relative to the first module-forming portion 85. The first and second module forming portions 85, 90 of the round module builder 80 are configured to form a round bale of cotton 100.

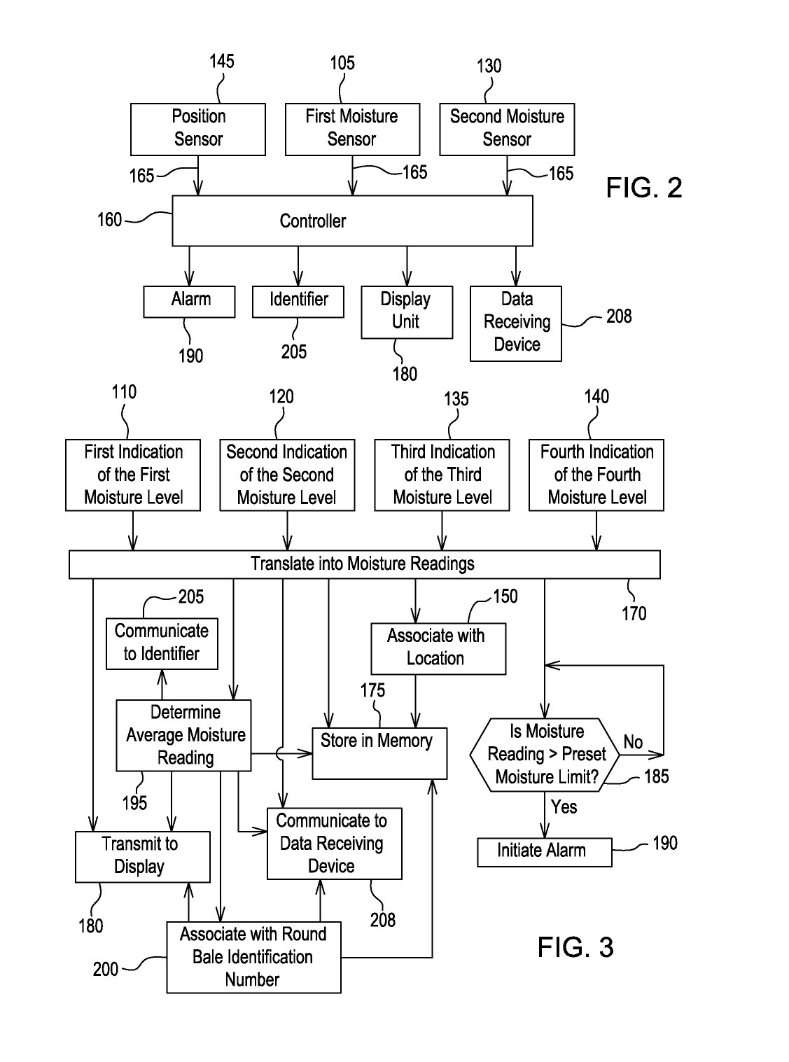

Exemplarily, a first moisture sensor 105 is coupleable to the first module-forming portion 85. Referring to FIGS. 1 and 2, the first moisture sensor 105 may be a resistance sensor, a capacitance sensor, or other type of sensor. The first moisture sensor 105 is configured to measure a first indication of a first moisture level 110 (FIG. 3) of the cotton adjacent an innermost portion 115 of the round bale of cotton 100. The first moisture sensor 105 is configured to measure a second indication of a second moisture level 120 (FIG. 3) of the cotton adjacent an outermost portion 125 of the round bale of cotton 100. It is contemplated that the first moisture sensor 105 may take additional measurements and may take measurements while the cotton is either moving or stationary. The first moisture sensor 105 may take measurements before or after the round bale of cotton 100 is formed.

Exemplarily, a second moisture sensor 130 is coupleable to the second module-forming portion 90. The second moisture sensor 130 may be a resistance sensor, a capacitance sensor, or other type of sensor. The second moisture sensor 130 is configured to measure a third indication of a third moisture level 135 (FIG. 3) of the cotton adjacent an innermost portion 115 of the round bale of cotton 100. The second moisture sensor 130 is configured to measure a fourth indication of a fourth moisture level 140 (FIG. 3) of the cotton adjacent an outermost portion 125 of the round bale of cotton 100. It is contemplated that the second moisture sensor 130 may make additional measurements and may take measurements while the cotton is either moving or stationary. The second moisture sensor 130 may take measurements before or after the round bale of cotton 100 is formed. Additional moisture sensors may be used or one moisture sensor may be used.

With reference to FIGS. 1 and 2, the cotton harvester 10 may comprise a position sensor 145 (e.g., GPS). In the embodiment shown in FIG. 1, the position sensor 145 is positioned on the accumulator 65. Alternatively, the position sensor 145 may be positioned elsewhere on the cotton harvester 10. The position sensor 145 is configured to associate a location 150 in the field 35 with at least one of the first, second, third, and fourth indications of a moisture level 110, 120, 135, 140 (FIG. 3). It is contemplated that the position sensor 145 may associate the location 150 in the field 35 with some, all, or none of the measurements of the first and second moisture sensors 105, 130.

A module handling system 155 is positioned adjacent the round module builder 80 for receiving the round bale of cotton 100. The module handling system 155 temporarily supports the round bale of cotton 100 and then discharges it from the cotton harvester 10.

In operation, the cotton harvester 10 is driven through the field 35 to harvest cotton. The illustrated harvesting structure 55 doffs the cotton from cotton plants in the field 35. Alternatively the harvesting structure 55 may strip the cotton from the cotton plants. Cotton is transferred to the accumulator 65 via the air duct system 60. The accumulator 65 holds the cotton until a predetermined cotton level is reached and then transfers the cotton to the feeder 70. In an exemplary embodiment, the accumulator 65 transfers cotton to the feeder 70 four times for each round bale of cotton 100 produced. When the feeder 70 receives cotton, the plurality of rollers 75 are activated to compress the cotton. The compressed cotton is transferred to the round module builder 80.

After the round module builder 80 receives compressed cotton, it starts rotating the cotton into the round bale 100. After the round module builder 80 stops receiving cotton from the feeder 70, it stops rotating. The first moisture sensor 105 is configured to measure the first indication of the first moisture level 110 of the cotton adjacent the innermost portion 115 of the round bale of cotton 100. The first moisture sensor 105 is configured to measure the second indication of the second moisture level 120 of the cotton adjacent the outermost portion 125 of the round bale of cotton 100. The first moisture sensor 105 can make measurements while the round module builder 80 is moving or stationary.

The second moisture sensor 130 is configured to measure the third indication of the third moisture level 135 of the cotton adjacent the innermost portion 115 of the round bale of cotton 100. The second moisture sensor 130 is configured to measure the fourth indication of the fourth moisture level 140 of the cotton adjacent the outermost portion 125 of the round bale of cotton 100. The second moisture sensor 130 can make measurements while the round module builder 80 is moving or stationary.

With reference to FIGS. 2 and 3, the position sensor 145 associates the location 150 in the field 35 with at least one of the first, second, third, and fourth indications of the moisture levels 110, 120, 135, 140, which are communicated to a controller 160 by a wired or wireless connection 165.

The controller 160 is programmed with logic to translate the first, second, third, and fourth indications of the moisture levels 110, 120, 135, 140 into moisture readings 170. The controller 160 is configured to associate the moisture readings 170 with the specific location 150 in the field 35. The moisture readings 170 and associated locations 150 may be stored in memory 175. The moisture readings 170 may be transmitted to a display unit 180 in the operator station 40. If a preset moisture limit 185 is exceeded, an alarm 190 may be initiated. The alarm 190 may be audio, visual, or other types.

The controller 160 is programmed with logic to determine an average moisture reading 195 while the round bale of cotton 100 is being formed and/or once the round bale of cotton 100 is completed. The average moisture reading 195 may be stored in memory 175. The average moisture reading 195 may be associated with a round bale identification number 200, which may be stored to memory 175. The controller 160 may communicate the average moisture reading 195 and/or the round bale identification number 200 to the display unit 180. The controller 160 may communicate the average moisture reading 195 to an identifier 205 that is coupleable to the round bale of cotton 100. The identifier 205 may be configured to communicate the average moisture reading 195. The controller 160 may communicate the moisture readings 170, the average moisture reading 195, and/or the round bale identification number 200 to a data receiving device 208 (e.g., cloud, server, computer).

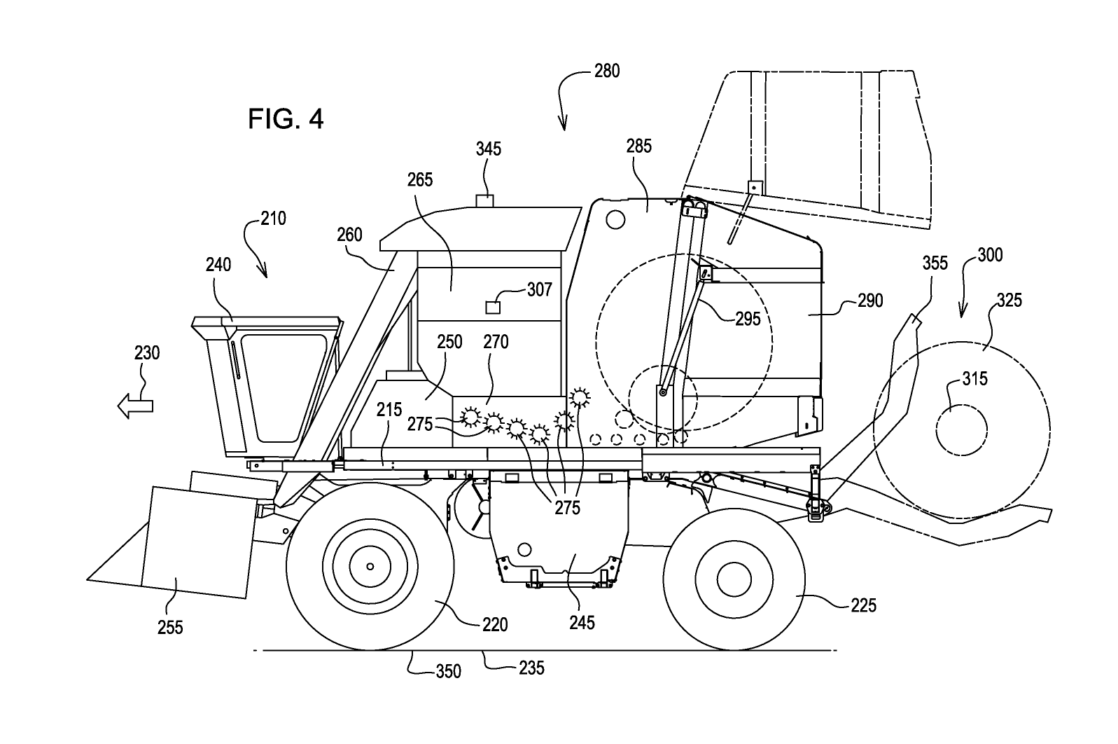

FIG. 4 illustrates a cotton harvester 210 according to another embodiment. The cotton harvester 210 includes features similar to the cotton harvester 10 of FIG. 1, and therefore, like components have been given like reference numbers plus 200 and only differences between the cotton harvesters 10 and 210 will be discussed in detail below.

An accumulator moisture sensor 307 is coupleable to the accumulator 265. The accumulator moisture sensor 307 is configured to measure an indication of a moisture level of the cotton as it accumulates and compresses under the weight of the cotton in the accumulator 265. The accumulator moisture sensor 307 is configured to measure the indication of the moisture level while the cotton is stationary in the accumulator 265. Alternatively, the accumulator moisture sensor 307 is configured to measure the indication of the moisture level while the cotton is moving to the feeder 270. The accumulator moisture sensor 307 may make at least two measurements while the cotton is in the accumulator 265.

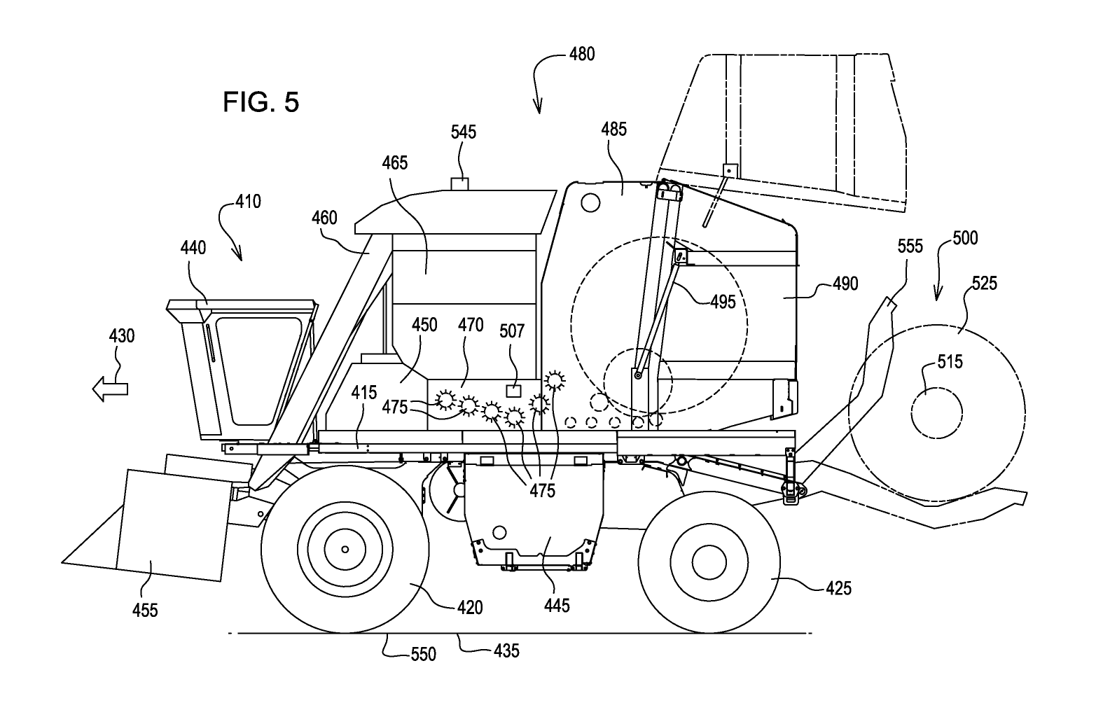

FIG. 5 illustrates a cotton harvester 410 according to another embodiment. The cotton harvester 410 includes features similar to the cotton harvester 10 of FIG. 1, and therefore, like components have been given like reference numbers plus 400 and only differences between the cotton harvesters 10 and 410 will be discussed in detail below.

A feeder moisture sensor 507 is coupleable to the feeder 470. The feeder moisture sensor 507 is configured to measure an indication of a moisture level of the cotton while it is stationary in the feeder 470. Alternatively, the feeder moisture sensor 507 is configured to measure the indication of the moisture level while the cotton is moving through the feeder 470. The feeder moisture sensor 507 may make at least two measurements while the cotton is moving through the feeder 470.

Various features are set forth in the following claims.

What is claimed is:

1. A cotton harvester comprising:
a harvesting structure configured to remove cotton from a field;
an accumulator in communication with the harvesting structure for receiving cotton therefrom;
a feeder in communication with the accumulator for receiving cotton therefrom, the feeder configured to compress the cotton;
a round module builder in communication with the feeder for receiving cotton therefrom, the round module builder configured to form a round bale of cotton; and
at least one moisture sensor coupleable to at least one of the accumulator, the feeder, and the round module builder, the moisture sensor configured to measure an indication of a moisture level of the cotton.

2. The cotton harvester of claim 1, wherein the moisture sensor is configured to measure the indication of the moisture level of the cotton while the cotton is stationary in at least one of the accumulator, the feeder, and the round module builder.

3. The cotton harvester of claim 1, wherein the moisture sensor is configured to measure the indication of the moisture level of the cotton at least twice per round bale of cotton.

4. The cotton harvester of claim 1, further comprising a position sensor configured to associate the indication of the moisture level of the cotton with a location in the field.

5. The cotton harvester of claim 1, wherein the moisture sensor is configured to measure the indication of the moisture level of the cotton while the cotton is moving in the round module builder.

6. The cotton harvester of claim 1, wherein the moisture sensor is configured to measure the indication of the moisture level of the cotton while the cotton is moving through the feeder.

7. The cotton harvester of claim 6, wherein the moisture sensor is configured to measure the indication of the moisture level of the cotton at least twice while the cotton is moving through the feeder.

8. The cotton harvester of claim 1, wherein the moisture sensor is at least one of a resistance sensor and a capacitance sensor.

9. A round module builder for forming a round bale of a cotton, the round module builder comprising:
a first module-forming portion configured to receive compressed cotton;
a second module-forming portion pivotally coupleable to the first module-forming portion, the first module-forming portion and the second module-forming portion configured to rotate the cotton into the round bale;
an extendable and retractable cylinder coupleable to the second module-forming portion and configured to pivot the second module-forming portion relative to the first module-forming portion; and
at least one moisture sensor coupleable to at least one of the first module-forming portion and the second module-forming portion;
wherein the moisture sensor is configured to measure a first indication of a first moisture level of the cotton adjacent an innermost portion of the round bale of cotton and a second indication of a second moisture level of the cotton adjacent an outermost portion of the round bale of cotton.

10. The round module builder of claim 9, wherein the moisture sensor is configured to measure the first and second indications while the cotton is stationary in the first module-forming portion and the second module-forming portion, respectively.

11. The round module builder of claim 9, wherein the moisture sensor is configured to measure the first and second indications while the cotton is moving in the first module-forming portion and the second module-forming portion, respectively.

12. The round module builder of claim 9, further comprising a second moisture sensor coupleable to at least one of the first module-forming portion and the second module-forming portion.

13. A method for baling cotton comprising:
compressing harvested cotton;
measuring a first indication of a first moisture level of the cotton adjacent an innermost portion of a round bale of cotton and a second indication of a second moisture level of the cotton adjacent an outermost portion of the round bale of cotton; and
ejecting the round bale of cotton from a round module builder.

14. The method of claim 13, further comprising generating a signal when at least one of the first and second indications exceeds a moisture level set point.

15. The method of claim 13, further comprising storing at least one of the first and second indications to memory.

16. The method of claim 15, further comprising associating at least one of the first and second indications with a location in a field and storing to memory.

17. The method of claim 15, further comprising determining an average moisture reading.

18. The method of claim 17, further comprising at least one of the following:
communicating the average moisture reading; and displaying the average moisture reading.

19. The method of claim 17, further comprising associating the average moisture reading to a round bale identification number.

20. The method of claim 19, further comprising placing an identifier on the round bale, the identifier configured to communicate the average moisture reading.
